(19) United States
(12) Patent Application Publication
(10) Pub. No.: US 2025/0340084 A1
(43) Pub. Date: Nov. 6, 2025

(54) MODULAR SYSTEM FOR STAMPING CONCRETE

(71) Applicant: PATTERNED CONCRETE INDUSTRIES LTD, Toronto (CA)

(72) Inventors: Andrew GUIDA, Toronto, CA (US); Joe GUIDA, Toronto (CA)

(21) Appl. No.: 19/196,831

(22) Filed: May 2, 2025

Related U.S. Application Data
(60) Provisional application No. 63/641,994, filed on May 3, 2024.

(51) Int. Cl. B44C 1/24

(52) U.S. Cl. CPC B44C 1/24

(57) ABSTRACT

A system for stamping a texture pattern onto a wet concrete surface, comprising a stamping member and a plurality of texture members. The stamping member comprises an upwardly facing standing side and a downwardly facing connection side, the downwardly facing connection side comprising a plurality of connection members. The plurality of texture members each comprise a downwardly facing textured surface and a connector member for connecting to one of the connection members. The texture pattern is selectable by selecting an arrangement of the plurality of texture members that are connected to the connection members.

### RELATED APPLICATION

This application claims priority to the 3 May 2024 filing date of U.S. Provisional Patent Application Ser. No. 63/641,994, which is incorporated herein by reference.

### FIELD OF THE INVENTION

This invention relates to stamped concrete, and more particularly to a modular system for stamping concrete.

### BACKGROUND OF THE INVENTION

It is known to use stamping tools to apply different textures and patterns to concrete surfaces, to improve the aesthetic appearance thereof. Current stamping tools are limited to a particular texture and/or pattern for each tool. As a result, contractors wishing to have a variety of stamping options need to buy many different stamping tools, which can be expensive and bulky to store.

### SUMMARY OF THE INVENTION

To at least partially overcome some of the disadvantages of previously known systems, devices and methods, in one aspect the present invention provides a system for stamping a texture pattern onto a wet concrete surface. The system includes a stamping member and a plurality of texture members. The stamping member has an upwardly facing standing side and a downwardly facing connection side. The downwardly facing connection side has a plurality of connection members. The plurality of texture members each have a downwardly facing textured surface and a connector member for connecting to one of the connection members. The texture pattern is selectable by selecting an arrangement of the plurality of texture members that are connected to the connection members.

The applicant has appreciated that the system in accordance with the invention allows a single stamping tool to be used to apply a variety of different textures and patterns to concrete surfaces. In particular, the system may include a wide variety of different texture members, which may be selected and arranged to create a wide array of different texture patterns.

In an especially preferred embodiment of the invention, the stamping member is made up of two detachable pieces: a standing mat and a pattern adapter. The standing mat provides a surface for a user to stand on in order to stamp the concrete. The pattern adapter has a plurality of connection members, which are arranged in a pattern. Preferably, the system includes a plurality of pattern adapters, each having a different pattern of connection members. For example, a first pattern adapter might include connection members for connecting square texture members in a 4 by 4 array; a second pattern adapter might include connection members for connecting larger square texture members in a 2 by 2 array; and a third pattern adapter might include connection members for connecting rectangular texture members in a 2 by 4 array.

Having a plurality of detachable pattern adapters preferably further increases the variety of different textures and patterns that can be applied using the system.

Accordingly, in one aspect the present invention resides in a system for stamping a texture pattern onto a concrete surface, comprising: a stamping member; and a plurality of texture members; wherein the stamping member comprises: an upwardly facing standing side; and a downwardly facing connection side, the downwardly facing connection side comprising a plurality of connection members; wherein the plurality of texture members each comprise: a downwardly facing textured surface; and a connector member for connecting to one of the connection members; wherein the texture pattern is selectable by selecting an arrangement of the plurality of texture members that are connected to the connection members.

In preferred embodiments, the stamping member comprises: a standing mat; and a pattern adapter; wherein the standing mat comprises an attachment member and the upwardly facing standing side of the stamping member; wherein the pattern adapter comprises an attaching member and the downwardly facing connection side of the stamping member; wherein the attachment member attaches to the attaching member; and wherein the plurality of connection members are arranged in a pattern.

In some preferred embodiments, the pattern member is a first pattern member, the plurality of connection members is a first plurality of connection members, and the pattern is a first pattern; wherein the system further comprises a second pattern member comprising a second plurality of connection members arranged in a second pattern; wherein the first pattern adapter is removable from the standing mat; and wherein the second pattern adapter is attachable to the standing mat when the first pattern adapter is removed.

Further aspects of the invention include:

A system for stamping a texture pattern onto a concrete surface, which optionally incorporates one or more features of any one or more of the preceding and/or following aspects, the system comprising: a stamping member; and a plurality of texture members; wherein the stamping member comprises: an upwardly facing side; and a downwardly facing side, the downwardly facing side comprising a plurality of connection members; wherein the plurality of texture members each have a downwardly facing textured surface; and wherein at least some of the plurality of texture members are connectable to at least some of the plurality of connection members in a plurality of different arrangements.

A system, which optionally incorporates one or more features of any one or more of the preceding and/or following aspects, wherein the upwardly facing side of the stamping member comprises a standing mat; wherein the downwardly facing side of the stamping member comprises a pattern adapter; wherein the plurality of connection members are arranged in a pattern; and wherein the pattern adapter is removably attached to the standing mat.

A system, which optionally incorporates one or more features of any one or more of the preceding and/or following aspects, wherein the pattern adapter is a first pattern adapter, the plurality of connection members is a first plurality of connection members, the pattern is a first pattern, and the plurality of different arrangements is a first plurality of different arrangements; wherein the system further comprises a second pattern adapter comprising a second plurality of connection members arranged in a second pattern; wherein the second pattern adapter is attachable to the standing mat when the first pattern adapter is removed from the standing mat; and wherein at least some of the plurality of texture members are connectable to at least some of the second plurality of connection members in a second plurality of different arrangements.

A system, which optionally incorporates one or more features of any one or more of the preceding and/or following aspects, wherein the system further comprises a third pattern adapter comprising a third plurality of connection members arranged in a third pattern; wherein the third pattern adapter is attachable to the standing mat when the first pattern adapter and the second pattern adapter are removed from the standing mat; and wherein at least some of the plurality of texture members are connectable to at least some of the third plurality of connection members in a third plurality of different arrangements.

A system, which optionally incorporates one or more features of any one or more of the preceding and/or following aspects, wherein the standing mat has a flat upper surface, and at least one handle that protrudes upwardly from the flat upper surface.

A system, which optionally incorporates one or more features of any one or more of the preceding and/or following aspects, wherein the standing mat attaches to the pattern adapter using at least one of: a snap fit connection and a magnetic connection.

A system, which optionally incorporates one or more features of any one or more of the preceding and/or following aspects, wherein at least some of the plurality of texture members are connectable to at least some of the plurality of connection members using at least one of: a snap fit connection and a magnetic connection.

A system, which optionally incorporates one or more features of any one or more of the preceding and/or following aspects, wherein at least some of the plurality of texture members are connectable to at least some of the plurality of connection members in multiple different orientations.

A system, which optionally incorporates one or more features of any one or more of the preceding and/or following aspects, wherein the pattern adapter has a joint forming member that defines a plurality of texture member receiving cavities.

A system, which optionally incorporates one or more features of any one or more of the preceding and/or following aspects, wherein a first subset of the plurality of texture members are connectable to the first plurality of connection members, and a second subset of the plurality of texture members are connectable to the second plurality of connection members; and wherein the first subset of the plurality of texture members have a different size and/or shape than the second subset of the plurality of texture members.

A system, which optionally incorporates one or more features of any one or more of the preceding and/or following aspects, wherein the pattern adapter is wider than the standing mat.

A system, which optionally incorporates one or more features of any one or more of the preceding and/or following aspects, wherein the standing mat has a flat upper surface, and at least one handle that protrudes upwardly from the flat upper surface; wherein the pattern adapter is wider than the standing mat; wherein at least some of the plurality of texture members are connectable to at least some of the first plurality of connection members in multiple different orientations; wherein the pattern adapter has a joint forming member that defines a plurality of texture member receiving cavities; wherein a first subset of the plurality of texture members are connectable to the first plurality of connection members, and a second subset of the plurality of texture members are connectable to the second plurality of connection members; and wherein the first subset of the plurality of texture members have a different size and/or shape than the second subset of the plurality of texture members.

A method, which optionally incorporates one or more features of any one or more of the preceding and/or following aspects, comprising: connecting a plurality of texture members to a plurality of connection members on an underside of a stamping member; and stamping a texture pattern onto a concrete surface using the stamping member; wherein the plurality of texture members each have a downwardly facing textured surface; and wherein the plurality of texture members are connectable to the plurality of connection members in a plurality of different arrangements.

A method, which optionally incorporates one or more features of any one or more of the preceding and/or following aspects, wherein connecting the plurality of texture members to the plurality of connection members comprises arranging the texture members in a first arrangement; the method further comprising: rearranging the texture members into a second arrangement that is different from the first arrangement.

A method, which optionally incorporates one or more features of any one or more of the preceding and/or following aspects, wherein rearranging the texture members into the second arrangement comprises changing an orientation of at least one of the texture members.

A method, which optionally incorporates one or more features of any one or more of the preceding and/or following aspects, wherein the plurality of texture members comprises a first plurality of texture members; the method further comprising: removing the first plurality of texture members from the plurality of connection members; and connecting a second plurality of texture members to the plurality of connection members, the second plurality of texture members having different textured surfaces than the first plurality of texture members.

A method, which optionally incorporates one or more features of any one or more of the preceding and/or following aspects, wherein the stamping member comprises a first pattern adapter that is removably attached to a standing mat; the method further comprising: removing the first pattern adapter from the standing mat.

A method, which optionally incorporates one or more features of any one or more of the preceding and/or following aspects, wherein the plurality of connection members are a first plurality of connection members arranged in a first pattern; and wherein the first pattern adapter comprises the first plurality of connection members; the method further comprising: attaching a second pattern adapter to the standing mat, the second pattern adapter comprising a second plurality of connection members arranged in a second pattern.

A method, which optionally incorporates one or more features of any one or more of the preceding and/or following aspects, wherein the plurality of texture members comprises a first plurality of texture members; the method further comprising: connecting a second plurality of texture members to the second plurality of connection members; wherein the first plurality of texture members have a different size and/or shape than the second plurality of texture members.

A method, which optionally incorporates one or more features of any one or more of the preceding and/or following aspects, wherein the plurality of texture members comprises a first plurality of texture members; the method further comprising: removing the first plurality of texture members from the plurality of connection members; and connecting a second plurality of texture members to the plurality of connection members, the second plurality of texture members having different textured surfaces than the first plurality of texture members; wherein the stamping member comprises a first pattern adapter that is removably attached to a standing mat; the method further comprising: removing the first pattern adapter from the standing mat; wherein the plurality of connection members are a first plurality of connection members arranged in a first pattern; and wherein the first pattern adapter comprises the first plurality of connection members; the method further comprising: attaching a second pattern adapter to the standing mat, the second pattern adapter comprising a second plurality of connection members arranged in a second pattern; and connecting a third plurality of texture members to the second plurality of connection members; wherein the first plurality of texture members have a different size and/or shape than the third plurality of texture members.

### BRIEF DESCRIPTION OF THE DRAWINGS

Further aspects and advantages of the invention will appear from the following description taken together with the accompanying drawings, in which:

FIG. 1 is a side view of a stamping tool in accordance with a first embodiment of the present invention;

FIG. 2 is an exploded side view of the stamping tool shown in FIG. 1;

FIG. 3 is a top view of a standing mat of the stamping tool shown in FIG. 1;

FIG. 4 is a bottom view of the standing mat shown in FIG. 3;

FIG. 5 is a top view of a pattern adapter of the stamping tool shown in FIG. 1;

FIG. 6 is a bottom view of the pattern adapter shown in FIG. 5;

FIG. 7 is a top view of a plurality of texture members of the stamping tool shown in FIG. 1;

FIG. 8 is a bottom view of the plurality of texture members shown in FIG. 7;

FIG. 9 is a bottom view of an alternative arrangement of the plurality of texture members shown in FIG. 8;

FIG. 10 is a bottom view of an alternate set of texture members suitable for attachment to the pattern adapter shown in FIG. 5;

FIG. 11 is a bottom view of a second pattern adapter suitable for attachment to the standing mat shown in FIG. 3;

FIG. 12 is a bottom view of a set of larger texture members suitable for attachment to the second pattern adapter shown in FIG. 11; and

FIG. 13 is a schematic top view of a custom image producible by the system in accordance with the present invention,

### DETAILED DESCRIPTION OF THE DRAWINGS

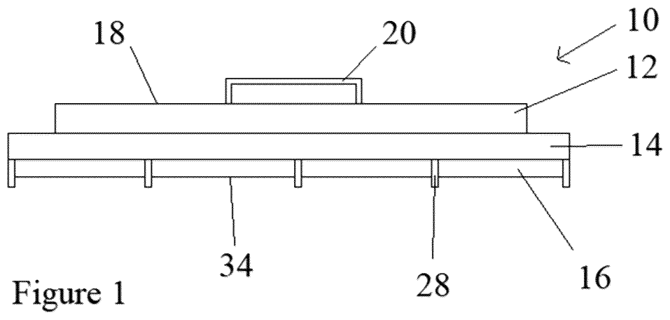

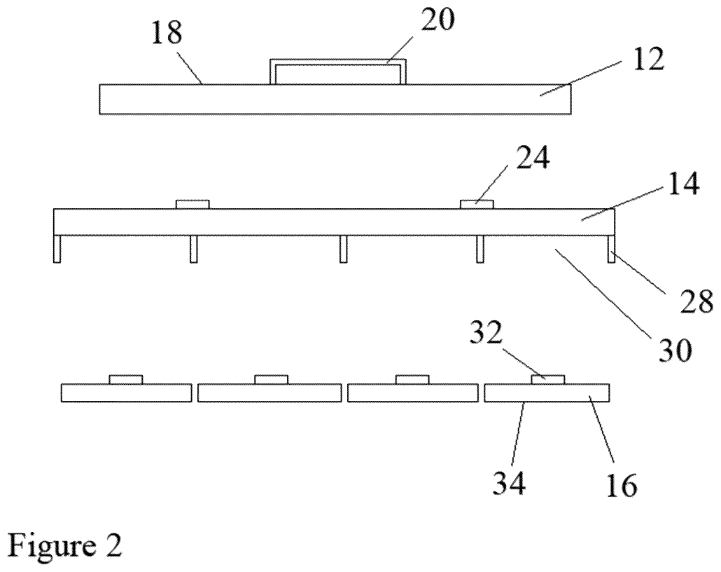

Reference is made to FIGS. 1 and 2, which show a stamping tool 10 in accordance with an embodiment of the present invention. As can be seen in FIG. 2, the stamping tool 10 includes a standing mat 12, a pattern adapter 14, and a plurality of texture members 16.

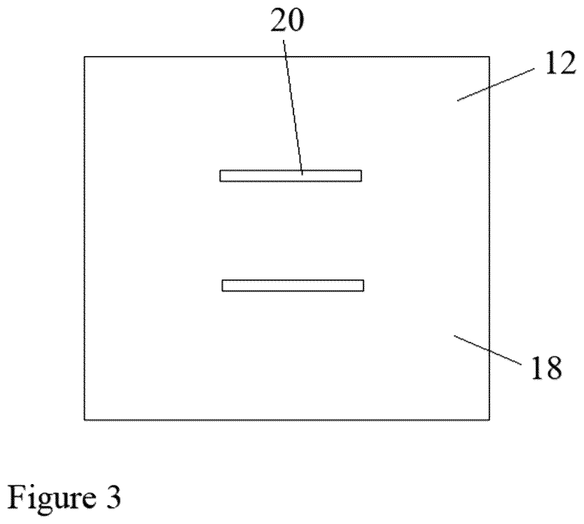

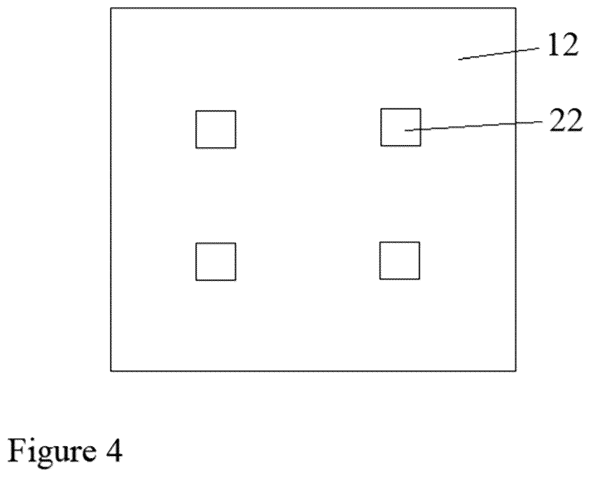

The standing mat 12 is formed from a rigid material, such as rigid polymers or steel, and has a flat upper surface 18. As can be seen in FIG. 3, two handles 20 protrude upwardly from the upper surface 18. As can be seen in FIG. 4, the underside of the standing mat 12 has a plurality of attachment members 22. The attachment members 22 are in the form of square shaped cavities, but any suitable structure for attaching the standing mat 12 to the pattern adapter 14 could be used.

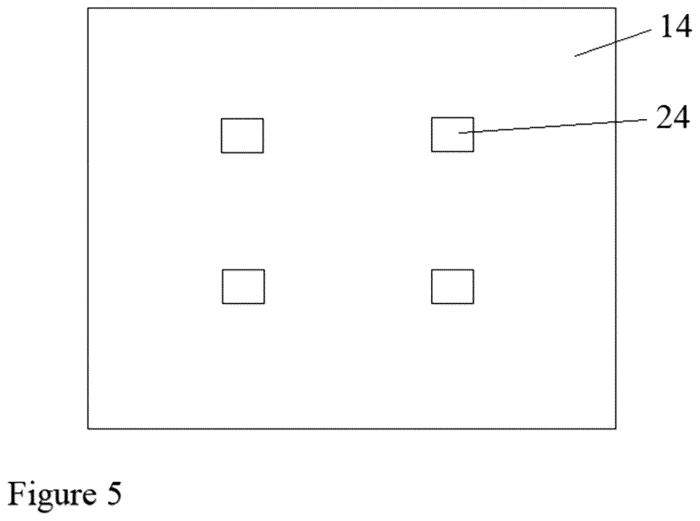

As can be seen in FIG. 5, the top of the pattern adapter 14 has a plurality of attaching members 24. The attaching members 24 are in the form of square shaped protrusions, which are configured to matedly engage with the attachment members 22 of the standing mat 12 to connect the pattern adapter 14 to the standing mat 12. Any other suitable form of attaching members 24 could be used. Optionally, the attachment members 22 and the attaching members 24 may incorporate magnets to help hold the pattern adapter 14 and the standing mat 12 together. Alternatively, a snap fit or any other suitable mechanism could be used to hold the pattern adapter 14 and the standing mat 12 together.

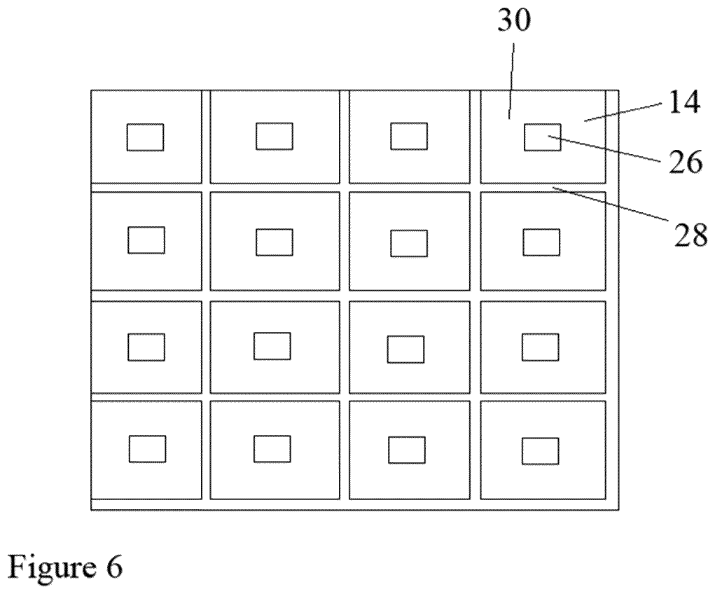

As can be seen in FIG. 6, the underside of the pattern adapter 14 has a plurality of connection members 26 which are arranged in a pattern. In the embodiment shown in FIG. 6, the connection members 26 are arranged in a 4 by 4 array. The connection members 26 are in the form of square shaped cavities, but any suitable structure for connecting the texture members 16 to the pattern adapter 14 could be used. The pattern adapter 14 also has a joint forming member 28 that extends downwardly so as to define a plurality of texture member receiving cavities 30.

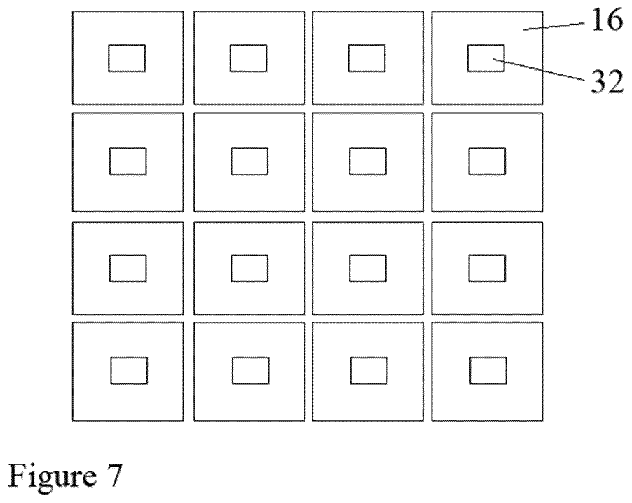

As can be seen in FIG. 7, the top of each of the texture members 16 has a connector member 32 for connecting to one of the connection members 26 of the pattern adapter 14. The connector members 32 are in the form of square shaped protrusions, which are configured to matedly engage with the connection members 26 of the pattern adapter 14 to connect the texture members 16 to the pattern adapter 14. Any other suitable form of connector members 32 could be used. Optionally, the connection members 26 and the connector members 32 may incorporate magnets to help hold the texture members 16 and the pattern adapter 14 together. Alternatively, a snap fit or any other suitable mechanism could be used to hold the texture members 16 and the pattern adapter 14 together.

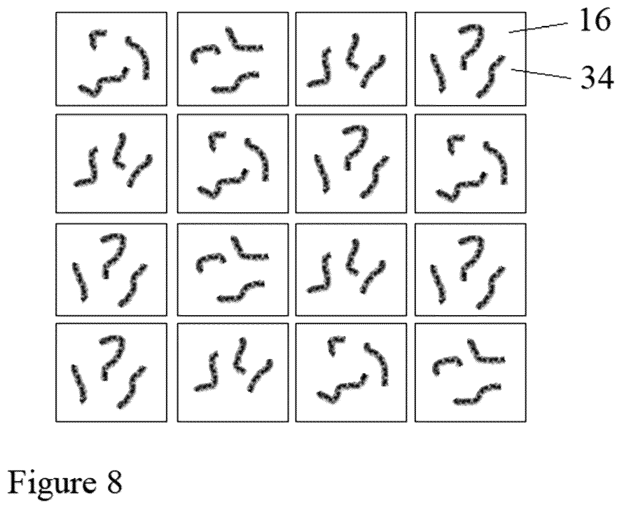

As can be seen in FIG. 8, each of the texture members 16 has a downwardly facing textured surface 34. When the texture members 16 are attached to the pattern adapter 14, the textured surfaces 34 are arranged in a texture pattern which can be impressed onto a concrete surface using the stamping tool 10.

The operation of the stamping tool 10 will now be described with reference to FIGS. 1 to 8. The stamping tool 10 is initially assembled by connecting the pattern adapter 14 to the underside of the standing mat 12, and connecting the texture members 16 to the underside of the pattern adapter 14 so that the textured surfaces 34 are arranged in a desired texture pattern. The stamping tool 10 is then placed onto the concrete surface to be stamped, for example by carrying the stamping tool 10 using the handles 20. A user then stands on the upper surface 18 of the standing mat 12, which pushes the textured surfaces 34 and the joint forming member 28 into the concrete, forming an impression in the concrete surface. The joint forming member 28 is preferably configured to form an impression in the concrete that resembles a joint, such as would exist between individual stones in a stone surface, so as to mimic the appearance of a stone surface. The stamping tool 10 is then removed from the concrete, for example by lifting the stamping tool 10 by the handles 20.

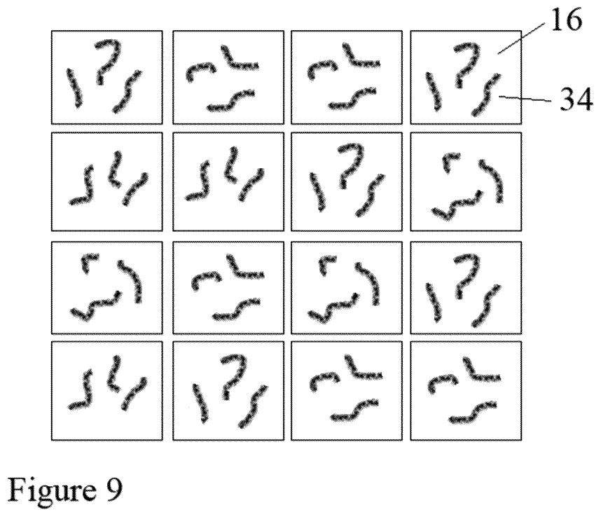

The stamping tool 10 in accordance with the invention allows for a great deal of customizability. For example, the texture members 16 can be arranged in any desired configuration to provide the desired texture pattern. An alternative arrangement of the texture members 16 is shown, for example, in FIG. 9.

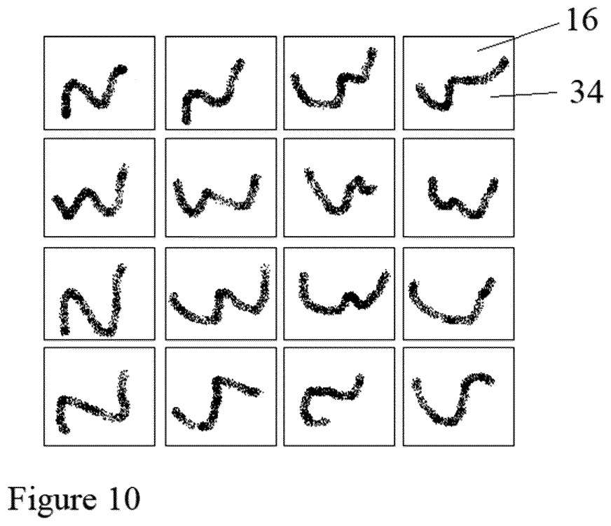

The stamping tool 10 as shown in FIGS. 1 to 9 preferably only forms part of a broader stamping system which also includes a selection of different texture members 16 and pattern adapters 14. For example, the system may also include the alternative set of texture members 16 shown in FIG. 10, which can be attached to the pattern adapter 14 to provide an alternative texture pattern.

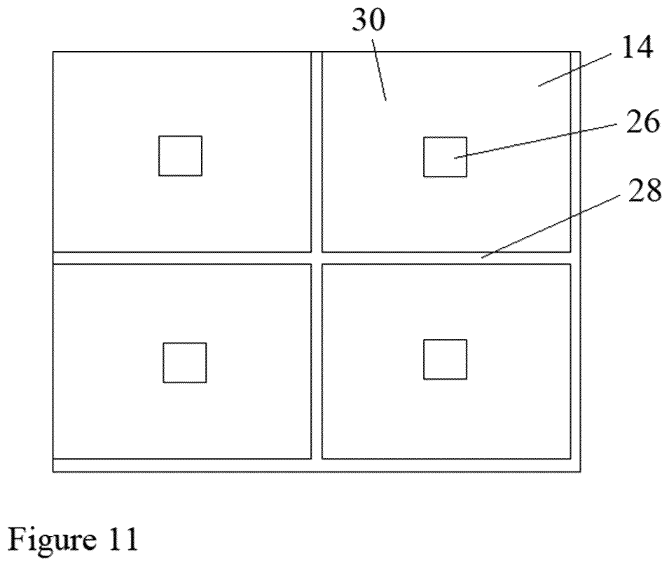

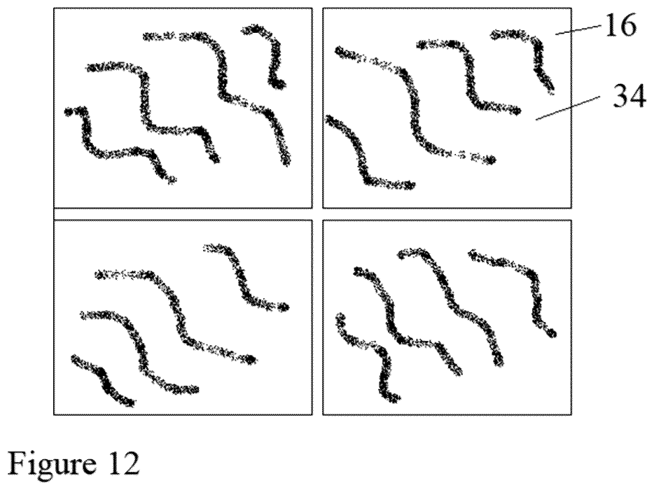

An alternative pattern adapter 14 is furthermore shown in FIG. 11, which is configured to receive larger texture members 16 in a 2 by 2 array. The pattern adapter 14 shown in FIG. 11 could be attached to the standing mat 12 shown in FIG. 3 in order to provide a texture pattern that mimics the appearance of larger stones, as compared to the pattern adapter 14 shown in FIG. 6 which mimics the appearance of smaller stones. A set of larger texture members 16 is shown in FIG. 12, which are suitable for attachment to the pattern adapter 14 shown in FIG. 11.

The system in accordance with the present invention thus provides a great deal of customizability, allowing a user to select from a wide array of different patterns and textures by selecting the pattern member 14 and the texture members 16 that are used.

It will be understood that, although various features of the invention have been described with respect to one or another of the embodiments of the invention, the various features and embodiments of the invention may be combined or used in conjunction with other features and embodiments of the invention as described and illustrated herein.

The invention is not limited to the particular preferred embodiments that are shown in the drawings. For example, in some less preferred embodiments of the invention, the standing mat 12 and the pattern adapter 14 are not detachable from each other and are formed as a single unit. When the standing mat 12 and the pattern adapter 14 are attached together, the resulting component is referred to herein as a stamping member. The standing mat 12 can also be referred to as a grill. The standing mat 12 is preferably flat and rigid, so as to remain level during the stamping process. In some embodiments of the invention, the standing mat 12 is designed to have a person stand on the upper surface 18 of the mat 12 to impress the texture pattern into the concrete. Any other suitable method of applying force to the mat 12 could also be used, such as tapping the mat 12 with a hammer or hands.

The standing mat 12 preferably has at least one handle 20, and more preferably at least two handles 20. Any suitable number of handles 20 could be used. In some preferred embodiments of the invention, the handles 20 have a fold-in mechanism that allows the handles 20 to be concealed within the body of the standing mat 12. This preferably allows a set of standing mats 12 to be easily stacked one on top of the other for storage while remaining level.

The standing mat 12 may have any suitable number of attachment members 22, and the pattern adapters 14 may have any suitable number of attaching members 24. The structure of the attachment members 22 and the attaching members 24 is not limited to the examples shown in the drawings. Rather, any suitable mechanism for attaching the pattern adapter 14 to the standing mat 12, while also allowing the pattern adapter 14 to be removed from the standing mat 12, could be used.

Preferably, the pattern adapter 14 is wider than the standing mat 12, so that the edges of the pattern adapter 14 are visible from above the standing mat 12. This preferably helps a user to more easily line up adjacent stamps.

Although the joint forming member 28 is shown in the drawings as being part of the pattern adapter 14, this is not necessary. For example, the joint forming member 28 could be a separate component that is attachable to the pattern adapter 14. Alternatively, the texture members 16 could each have their own joint forming members 28 that form the appearance of a joint when the texture members 16 are pressed into concrete. Preferably, the joint forming members 28 leave at least one side of the texture pattern joint free, so that the pattern can be repeated without forming a double joint between adjacent stamps. In some embodiments of the invention, the joint forming member 28 could be omitted entirely. In some embodiments, one or more sides of the joint forming member 28 could have a reduced width, preferably half the width of the intended joint. This preferably allows the pattern to be repeated without forming a double sized joint between adjacent stamps.

The pattern adapters 14 are not limited to the particular embodiments shown in the drawings. Rather, any suitable patterns could be used, including differently sized arrays and differently shaped joints. For example, the pattern adapter 14 could be configured to produce square, rectangular, triangular, or irregular shaped joint patterns. In some embodiments, the pattern adapter 14 is customizable, and may be used to produce abstract, intricate designs.

Optionally, the standing mats 12, the pattern adapters 14, the texture members 16, and the joint forming members 28 may be sold separately. Preferably, a user of the system in accordance with the invention, such as a contractor, would have multiple standing mats 12, multiple pattern adapters 14, and many texture members 16 with different sizes, shapes, and/or textured surfaces 34. In some preferred embodiments, a complete set would include at least eight to twelve standing mats 12, at least eight to twelve pattern adapters 14 for each pattern, and at least enough texture members 16 to fill the pattern adapters 14.

In some embodiments of the invention, the texture members 16 may be configured to transfer color to the concrete surface. In some embodiments of the invention, the texture members 16 may incorporate different materials to produce different textures and/or color impressions, including urethanes, fabrics, foams, sponges, plastics, metals, and/or paper or any other suitable materials or combinations thereof. In some embodiments, a single texture member 16 may incorporate multiple different materials, including more than one of the materials mentioned above.

The pattern adapter 14 may have any suitable number of connection members 26, and the texture members 16 may have any suitable number of connector members 32. The structure of the connection members 26 and the connector members 32 is not limited to the examples shown in the drawings. Rather, any suitable mechanism for attaching the texture members 16 to the pattern adapter 14, while also allowing the texture members 16 to be removed from the pattern adapter 14, could be used.

Preferably, all of the texture members 16 of a given size and shape are interchangeable, and can be attached to a pattern adapter 14 of a corresponding size and shape at any suitable position and/or orientation.

In one optional use of the stamping system, each stamp applied to a concrete surface can be made using a different arrangement of texture members 16, resulting in a surface that has no repeating patterns.

In some embodiments of the invention, the modular stamping tool described herein may be used in combination with other traditional stamping processes and/or stamping tools. For example, in some embodiments of the invention, the modular stamping tool described herein may be used to produce a pattern on a concrete surface, with other traditional processes and/or tools being used at the corners and/or beside verticals or structures.

In some preferred embodiments, the system uses non-traditionally used materials such as foams, sponges, or fabrics or others to offer the capability to color/dye the concrete at the same time of stamping within a desired pattern once the texture members 16 are placed in the pattern adapter 14. This allows intricate carpet-like patterns to be stamped into the concrete with unique coloring capabilities. For example, if a single texture member 16 that attaches into a single 2×2 square of the pattern adapter 14, this texture member 16 may use a combination of foam, plastic, sponge, fabrics or other materials in one singular texture member 16. Between the variance in the different materials in the texture members 16, colors can be transferred. Different materials allow for additional patterning within the texture members 16, as well as the capability to transfer color/dye to concrete in desired locations.

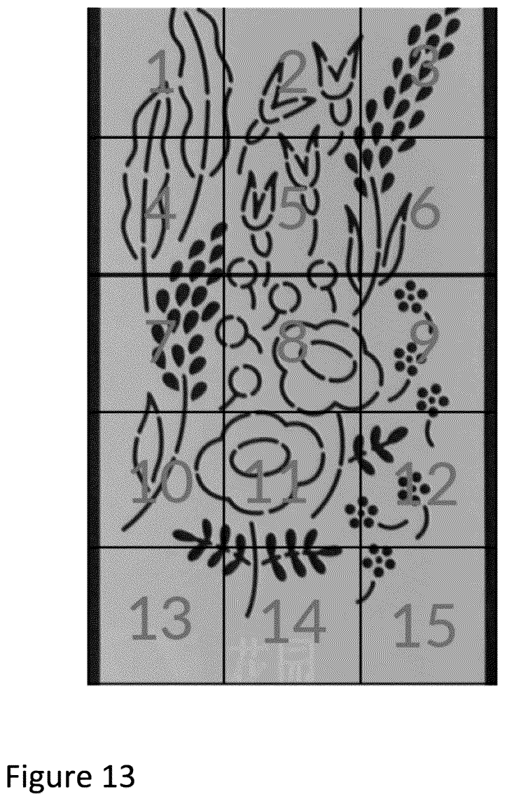

In some preferred embodiments, the system provides the ability to create large custom images stamped into concrete. For example, multiple standing mats 12 could be arranged over a large area of concrete, with each standing mat 12 having a pattern adapter 14 carrying a unique set of texture members 16, which together form a pre-designed detailed stenciled image to be stamped into the concrete. An example image is shown in FIG. 13, in which fifteen stamping tools 10 are arranged in a 3×5 array, each stamping tool 10 carrying a unique set of texture members 16 that together form the overall image. The image can furthermore be imprinted with a variety of colors through the use of different materials and colors/dyes as described above.

Although this disclosure has described and illustrated certain preferred embodiments of the invention, it is to be understood that the invention is not restricted to these particular embodiments. Rather, the invention includes all embodiments which are functional or mechanical equivalents of the specific embodiments and features that have been described and illustrated herein.

We claim:

1. A system for stamping a texture pattern onto a concrete surface, comprising:
a stamping member; and
a plurality of texture members;
wherein the stamping member comprises:
an upwardly facing side; and
a downwardly facing side, the downwardly facing side comprising a plurality of connection members;
wherein the plurality of texture members each have a downwardly facing textured surface; and
wherein at least some of the plurality of texture members are connectable to at least some of the plurality of connection members in a plurality of different arrangements.

2. The system according to claim 1, wherein the upwardly facing side of the stamping member comprises a standing mat;
wherein the downwardly facing side of the stamping member comprises a pattern adapter;
wherein the plurality of connection members are arranged in a pattern; and
wherein the pattern adapter is removably attached to the standing mat.

3. The system according to claim 2, wherein the pattern adapter is a first pattern adapter, the plurality of connection members is a first plurality of connection members, the pattern is a first pattern, and the plurality of different arrangements is a first plurality of different arrangements;
wherein the system further comprises a second pattern adapter comprising a second plurality of connection members arranged in a second pattern;
wherein the second pattern adapter is attachable to the standing mat when the first pattern adapter is removed from the standing mat; and
wherein at least some of the plurality of texture members are connectable to at least some of the second plurality of connection members in a second plurality of different arrangements.

4. The system according to claim 3, wherein the system further comprises a third pattern adapter comprising a third plurality of connection members arranged in a third pattern;
wherein the third pattern adapter is attachable to the standing mat when the first pattern adapter and the second pattern adapter are removed from the standing mat; and
wherein at least some of the plurality of texture members are connectable to at least some of the third plurality of connection members in a third plurality of different arrangements.

5. The system according to claim 2, wherein the standing mat has a flat upper surface, and at least one handle that protrudes upwardly from the flat upper surface.

6. The system according to claim 2, wherein the standing mat attaches to the pattern adapter using at least one of: a snap fit connection and a magnetic connection.

7. The system according to claim 1, wherein at least some of the plurality of texture members are connectable to at least some of the plurality of connection members using at least one of: a snap fit connection and a magnetic connection.

8. The system according to claim 1, wherein at least some of the plurality of texture members are connectable to at least some of the plurality of connection members in multiple different orientations.

9. The system according to claim 2, wherein the pattern adapter has a joint forming member that defines a plurality of texture member receiving cavities.

10. The system according to claim 3, wherein a first subset of the plurality of texture members are connectable to the first plurality of connection members, and a second subset of the plurality of texture members are connectable to the second plurality of connection members; and
wherein the first subset of the plurality of texture members have a different size and/or shape than the second subset of the plurality of texture members.

11. The system according to claim 2, wherein the pattern adapter is wider than the standing mat.

12. The system according to claim 3, wherein the standing mat has a flat upper surface, and at least one handle that protrudes upwardly from the flat upper surface;
wherein the pattern adapter is wider than the standing mat;
wherein at least some of the plurality of texture members are connectable to at least some of the first plurality of connection members in multiple different orientations;
wherein the pattern adapter has a joint forming member that defines a plurality of texture member receiving cavities;
wherein a first subset of the plurality of texture members are connectable to the first plurality of connection members, and a second subset of the plurality of texture members are connectable to the second plurality of connection members; and
wherein the first subset of the plurality of texture members have a different size and/or shape than the second subset of the plurality of texture members.

13. A method comprising:
connecting a plurality of texture members to a plurality of connection members on an underside of a stamping member; and
stamping a texture pattern onto a concrete surface using the stamping member;
wherein the plurality of texture members each have a downwardly facing textured surface; and
wherein the plurality of texture members are connectable to the plurality of connection members in a plurality of different arrangements.

14. The method according to claim 13, wherein connecting the plurality of texture members to the plurality of connection members comprises arranging the texture members in a first arrangement;
the method further comprising:
rearranging the texture members into a second arrangement that is different from the first arrangement.

15. The method according to claim 14, wherein rearranging the texture members into the second arrangement comprises changing an orientation of at least one of the texture members.

16. The method according to claim 13, wherein the plurality of texture members comprises a first plurality of texture members;
the method further comprising:
removing the first plurality of texture members from the plurality of connection members; and
connecting a second plurality of texture members to the plurality of connection members, the second plurality of texture members having different textured surfaces than the first plurality of texture members.

17. The method according to claim 13, wherein the stamping member comprises a first pattern adapter that is removably attached to a standing mat;
the method further comprising:
removing the first pattern adapter from the standing mat.

18. The method according to claim 17, wherein the plurality of connection members are a first plurality of connection members arranged in a first pattern; and
wherein the first pattern adapter comprises the first plurality of connection members;
the method further comprising:
attaching a second pattern adapter to the standing mat, the second pattern adapter comprising a second plurality of connection members arranged in a second pattern.

19. The method according to claim 18, wherein the plurality of texture members comprises a first plurality of texture members;
the method further comprising:
connecting a second plurality of texture members to the second plurality of connection members;
wherein the first plurality of texture members have a different size and/or shape than the second plurality of texture members.

20. The method according to claim 15, wherein the plurality of texture members comprises a first plurality of texture members;
the method further comprising:
removing the first plurality of texture members from the plurality of connection members; and
connecting a second plurality of texture members to the plurality of connection members, the second plurality of texture members having different textured surfaces than the first plurality of texture members;
wherein the stamping member comprises a first pattern adapter that is removably attached to a standing mat;
the method further comprising:
removing the first pattern adapter from the standing mat;
wherein the plurality of connection members are a first plurality of connection members arranged in a first pattern; and
wherein the first pattern adapter comprises the first plurality of connection members;
the method further comprising:
attaching a second pattern adapter to the standing mat, the second pattern adapter comprising a second plurality of connection members arranged in a second pattern; and
connecting a third plurality of texture members to the second plurality of connection members;
wherein the first plurality of texture members have a different size and/or shape than the third plurality of texture members.
